(19) United States
(12) Patent Application Publication
(10) Pub. No.: US 2008/0208433 A1
(43) Pub. Date: Aug. 28, 2008

(54) METHOD FOR AUTOMATIC CONTROL OF AIR/FUEL RATIO IN AN INTERNAL COMBUSTION ENGINE

(75) Inventor: Paul John Goodall, Treasure Island, FL (US)

Correspondence Address: BROWDY AND NEIMARK, P.L.L.C.;624 NINTH STREET, NW, SUITE 300, WASHINGTON, DC, 20001-5303, US

(73) Assignee: SELETTRA S.R.L., BENTIVOGLIO (IT)

(21) Appl. No.: 11/873,788

(22) Filed: Oct. 17, 2007

Related U.S. Application Data
(60) Provisional application No. 60/852,005, filed on Oct. 17, 2006.

(51) Int. Cl. F02D 41/00

(52) U.S. Cl. 701/103

(57) ABSTRACT

Method for automatic control of air/fuel ratio λ in an internal combustion engine equipped with catalyst comprises the following steps: measuring the temperature of the exhaust gases, or of the catalyst; keeping the engine at a constant feed and speed whilst the air/fuel ratio λ is varied with increases or decreases; selecting a value of λ for the operation of the engine that:

a) is close to the inversion of slope of the temperature curve T_{SC} of the exhaust gases according to λ; and
b) has excess fuel with respect to the air/fuel stechiometric ratio (λ<1).

The present invention refers to a method for automatic control of air/fuel ratio in an internal combustion engine.

The air/fuel ratio is known as λ and is 1 when it corresponds to the stechiometric value (λ=1); when λ is less than 1 (λ<1) the mixture is rich, i.e. it has excess fuel with respect to the stechiometric value, and when λ is greater than 1 (λ>1) the mixture is poor, i.e. it has excess air.

As known, accurate control of air/fuel ratio λ allows the performance parameters of a motor to be optimised, like for example fuel-saving and polluting emissions.

In order to improve the control system a closed cycle control is usually used that uses a feedback signal proportional to the air/fuel ratio λ.

Such a closed cycle system allows some factors that reduce the accuracy of the system to be compensated, like for example the production tolerances and the wear of the components, which it is not possible to correct with an open cycle system. The compensation of other factors, like the condition of the air and the filtering conditions of the air, which is not possible with an open cycle system, requires the use of additional sensors not required by the closed cycle system.

A great deal of development of emissions control methods has been carried out for applications in automobiles, like for example three-way catalyst systems. These systems allow the simultaneous reduction of the pollutants: carbon monoxide (CO), unburnt hydrocarbons (HC) and nitrogen oxides (NOₓ) and require accurate control of air/fuel ratio λ, which must remain within a narrow range around stechiometric combustion, which occurs when the mixture has a balanced theoretical ratio between air and fuel, i.e. without excess air or fuel.

To control the air/fuel ratio λ, special feedback devices are used, like for example sensors of oxygen in the exhaust gases.

A fuel control system that continually changes the flow of fuel during the monitoring of the exhaust gas temperature (known as EGT) until the engine operates at the maximum EGT value is known from U.S. Pat. No. 4,305,364. The flow of fuel is thus reduced by a predetermined value to have the engine operate at its maximum efficiency, measured as brake specific fuel consumption (BSFC), corresponding to the amount of fuel consumed in the unit of time per unit of power delivered by the engine.

The maximum EGT value is obtained when the air/fuel ratio λ is close to the stechiometric value since the excess fuel in rich mixtures cools down the current of exhaust gases; for poor mixtures the low amount of fuel reduces the total heat released and the exhaust gases are further cooled by the excess air.

The control system described in U.S. Pat. No. 4,953,351 uses a λ measurer for feedback control of the mixture in normal operating conditions of the engine. The temperature is measured at a catalytic converter arranged on the exhaust pipe.

The calibration point of the λ measurer (output signal for a known mixture) is determined by varying the air/fuel ratio to identify the point of change of slope in the graph that illustrates the catalyst temperature (Y-axis) against λ (X-axis).

This calibration of the lambda sensor takes place at predetermined time intervals.

For applications not intended for vehicles, the engines are designed to operate with richer than stechiometric mixtures.

Indeed, for some engines, especially high-performance engines, the excess fuel is necessary to obtain greater power delivered or to avoid the temperatures of the components inside it reaching high values, so as to limit wear. Moreover, some high-performance engines can be damaged if operated, even for a short time, with λ=1 or even with λ<1 (rich mixtures). Some engines, especially those used in portable devices, operate exclusively with λ<1 (mixtures richer than stechiometric) due to the low vaporisation of the fuel or early flame extinction.

The prior art does not allow for a method for automatic control of air/fuel ratio in an internal combustion engine that provides closed cycle control of the mixture at a value of λ<1.0.

The purpose of the present invention is to provide a method for automatic control of air/fuel ratio in an internal combustion engine having characteristics such as to satisfy the aforementioned requirements.

A further purpose of the present invention is to provide a method for automatic control of air/fuel ratio in an internal combustion engine that allow the use of a relatively low-precision sensor, within a simple, cost-effective and rational solution.

Such purposes are accomplished through a method for automatic control of air/fuel ratio in an internal combustion engine, which comprises the following steps:

measuring the temperature of the exhaust gases, or of the means placed in contact with them and foreseen to burn any residual product that has undergone partial or complete burning;

keeping the engine at a constant feed and speed whilst the air/fuel ratio λ is varied with increases or decreases;

selecting a value of λ for the operation of the engine that:

a) is close to the inversion of slope of the temperature curve T_{SC} of the exhaust gases according to λ; and

b) has excess fuel with respect to the air/fuel stechiometric ratio (λ<1).

Further characteristics and advantages of the invention shall become clearer from reading the following description, provided as an example and not limiting purposes, with the help of the figures illustrated in the attached tables, in which:

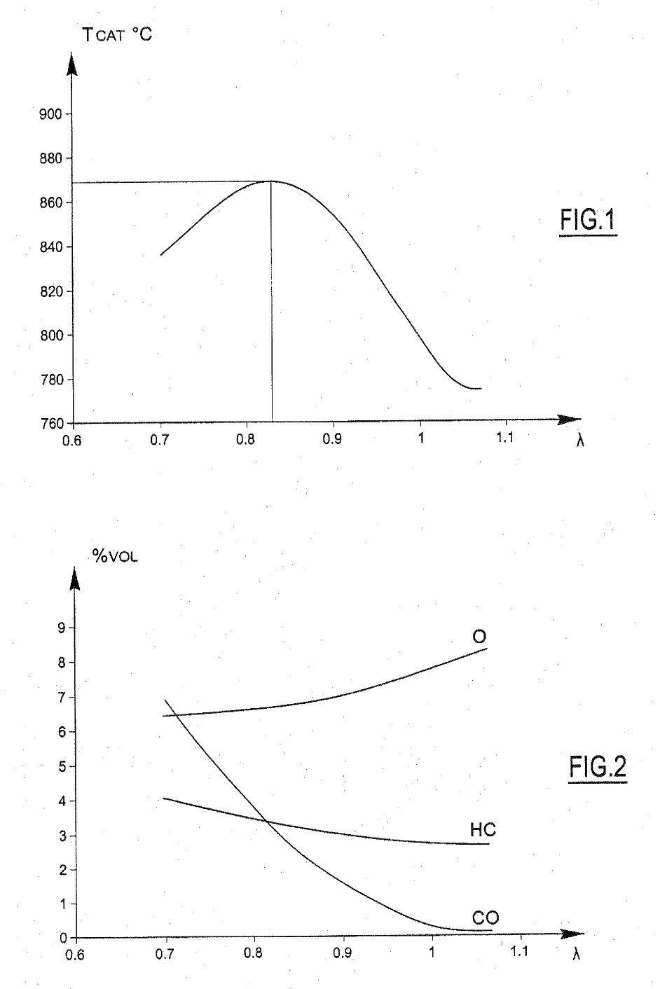

FIG. 1 shows a graph of the temperature at the catalyst according to λ;

FIG. 2 shows a graph of the oxygen, hydrocarbon and carbon monoxide concentrations according to λ;

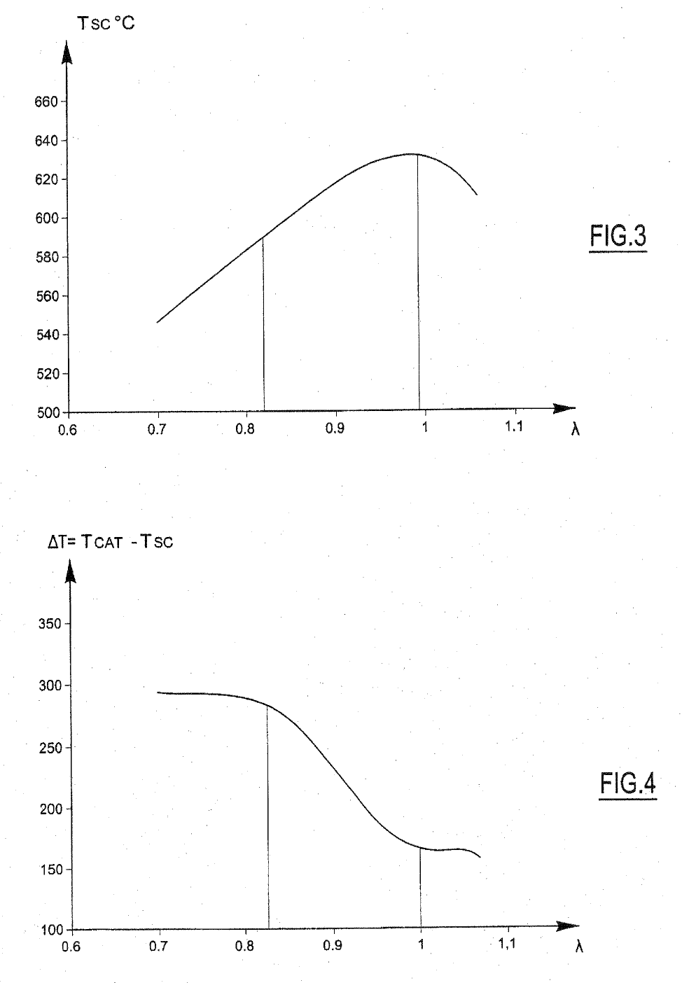

FIG. 3 shows a graph of the temperature T_{SC} of the exhaust gases upstream of the catalyst according to λ;

FIG. 4 shows a graph of the temperature difference between the temperature at the catalyst (T_{CAT}) and the temperature T_{SC} of the exhaust gases upstream of the catalyst according to λ;

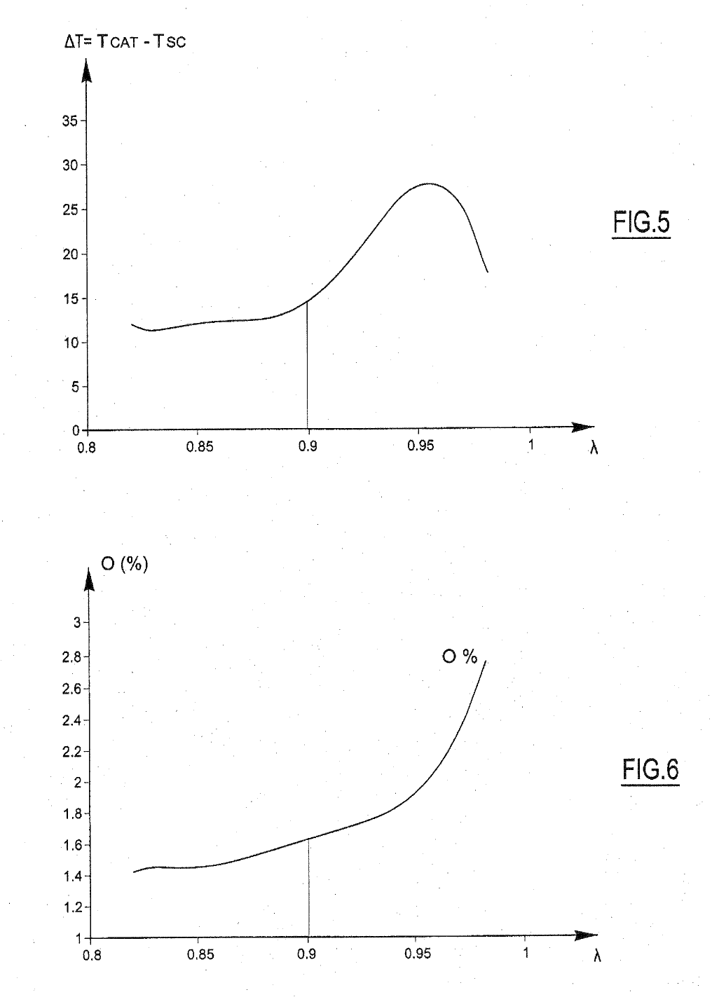

FIG. 5 shows a graph of the temperature difference between the temperature at the catalyst (T_{CAT}) and the temperature of the exhaust gases (T_{SC}) upstream of the catalyst according to λ, in accordance with a different embodiment.

FIG. 6 shows a graph of the oxygen concentration according to λ.

In accordance with the first embodiment of the present invention, relative to a two-stroke engine, the control method consists of providing:

an engine equipped with means for varying the air/fuel ratio λ,

an oxidation catalyst along the exhaust gas path, and

a temperature sensor positioned so as to measure the temperature (T_{SC}) of the exhaust gases after they have at least partially crossed the catalyst.

The catalyst can have the primary function of reducing the pollutants emitted by the engine, or it can be used just to promote the reaction of the combustible exhaust gases near to the temperature sensor of the described control system.

FIG. 1 shows the relationship between the air/fuel ratio (λ) and the temperature at the catalyst T_{CAT}, where T_{λMAX} indicates the value of λ at the maximum temperature at the catalyst.

During the operation of the engine at constant feed and speed, the value λ of the air/fuel mixture is moved incrementally, with a richer or poorer fuel flow.

In particular, if the temperature T_{CAT} at the catalyst increases, the mixture is moved again in the same direction as the first change, i.e. towards the right in FIG. 1 all the while it is to the left of T_{λMAX} and towards the left in FIG. 1 all the while it is to the right of T_{λMAX}.

If the temperature T_{CAT} decreases, the value λ of the air/fuel mixture is moved in the opposite direction to the previous change. Thanks to this method, the air/fuel ratio λ is adjusted so as to make the temperature at the catalyst T_{CAT} its maximum.

The engine can operate with this value λ of the mixture or else with a value other than λ based upon data previously acquired from engines of the same type.

The maximum temperature at the catalyst T_{SC} depends upon the value of the ratio between combustible gases and the oxygen in the current of exhaust gases.

FIG. 2 shows the relative concentration of oxygen, hydrocarbons (HC) and carbon monoxide (CO) according to lambda. The combustible gases HC and CO increase with richer air/fuel mixtures (towards the left) fed to the engine whilst the available oxygen decreases up to a substantially constant level for very rich mixtures.

FIG. 3 shows the temperature of the exhaust gases upstream of the catalyst, which has a maximum value close to the value of the stechiometric air/fuel ratio.

FIG. 4 shows the temperature difference between catalyst T_{CAT} and exhaust gases T_{SC}.

This temperature difference is proportional to the amount of heat flow, or reaction heat, that is generated in the oxidation of the HC and of the CO inside the current of exhaust gases. For poorer mixtures of λT_{λMAX} (value of λ at the maximum temperature), i.e. with values of λ in FIG. 1 to the right of (T_{MAX}), this reaction heat is limited by the available amount of these two combustion constituents (HC and CO); the temperature difference increases as the amounts of HC and CO increase. For richer mixtures of λT_{λMAX}, i.e. with values of lambda in FIG. 1 to the left of (T_{MAX}), the temperature difference remains substantially constant, as well as the reaction heat, indicative of the fact that the oxygen concentration in this situation limits the reaction.

Thanks to the present invention, the maximum temperature can be determined with a sensor with relatively low accuracy.

It is obvious that the difference between the temperature value measured and the value of the temperature corresponding to the standard calibration can depend upon various factors, including the production tolerances (both in terms of size and in terms of material composition), heat transfer from other sources and aging of the sensors themselves. However, these factors become less significant since the maximum temperature, in accordance with the present invention, is determined by taking the difference between the measured temperature value and the temperature value corresponding to the standard calibration as reference.

The elimination or reduction of any deviation between the measured values and the calibration temperature allows the results of the invention to be achieved.

In accordance with the second embodiment of the present invention, relative to a four-stroke engine, the control method consists of providing an engine as described in the first embodiment and two temperature sensors, one positioned so as to measure the temperature of the exhaust gases upstream of a catalytic converter, the other positioned so as to measure the temperature of the exhaust gases after they have at least partially crossed the converter, i.e. at the converter, or else the same temperature as the catalyst element.

The temperature difference, which is proportional to the amount of combustion reaction promoted by the catalyst, is observed whilst the value λ of the mixture at the engine is changed incrementally.

FIG. 5 shows the relationship between the temperature difference and the relative air/fuel ratio for an engine with a higher capacity of air and fuel mixture than that described in the first embodiment. A greater fuel capacity generates lower levels of hydrocarbons in the exhaust gas; a greater air capacity generates lower oxygen concentrations.

FIG. 6 shows the oxygen concentration at the exhaust according to λ.

For very rich mixtures (λ<1), the oxygen level is low and the combustion at the catalyst is almost zero, as can be seen from the small difference between T_{CAT} and T_{SC} in FIG. 5. A rapid change in the slope of the inclination of the temperature difference occurs for values of λ<0.90, due to an increase in the oxygen available.

The ratio λ of the mixture at the engine is initially gradually decreased. If the change in temperature is less than a predetermined threshold value, the ratio λ of the mixture at the engine is gradually increased towards poorer mixtures. The value λ of the mixture at the engine is modified towards poorer mixtures in the subsequent steps until the threshold value of the temperature difference has been exceeded, which occurs when the engine operates within the range of a value λ of the mixture where the temperature difference curve T_{CAT}−T_{SC} according to λ of the mixture at the engine changes the slope. If the initial step with the rich mixture modifies the temperature difference by a value greater than the threshold value, the engine operates with a poor mixture with respect to the point of change in slope and the mixture is increased in steps so that it is richer until the temperature difference falls below the threshold value.

Since this change in slope can be detected through the difference of two values, high accuracy of measurement of the temperature is not necessary for this control method.

As an alternative to the use of the catalyst, in order to reduce costs and increase lifetime, it is possible to use a thermal reactor.

As can be appreciated from that which has been described, the method for automatic control of air/fuel ratio in an internal combustion engine according to the present invention allows the requirements to be satisfied and the drawbacks mentioned in the introductory part of the present description with reference to the prior art to be overcome.

Of course, a man skilled in the art can bring numerous modifications and variants to the method for automatic control of air/fuel ratio in an internal combustion engine described above in order to satisfy contingent and specific requirements, all of which are covered by the scope of protection of the invention, as defined by the following claims.

1. Method for automatic control of air/fuel ratio λ in an internal combustion engine equipped with means for promoting the combustion of the residual combustible gases in the exhaust gas flow, characterised in that it comprises the following steps:
measuring the temperature T_{SC} of the exhaust gases, or of the means placed in contact with them and foreseen to burn any residual combustible product after partial or complete burning;
keeping the engine at a constant feed and speed whilst the air/fuel ratio λ is varied with increases or decreases;
selecting a value of λ for the operation of the engine that:
a) is close to the inversion of slope of the temperature curve T_{SC} of the exhaust gases according to λ; and
b) has fuel in excess with respect to the air/fuel stechiometric ratio (λ<1).

2. Method according to claim 1, wherein the temperature of the exhaust gases is measured upstream of the means for promoting the combustion of the residual combustible gases in the exhaust gas flow and the engine is operated with an air/fuel ratio λ that corresponds to the variation in slope of the curve according to λ of the difference between said temperature of the exhaust gases measured upstream of said means, and the temperature of the exhaust gases measured downstream of said means, according to λ respecting the condition λ<1.

3. Method according to claim 2, wherein said temperature measured downstream is the temperature of the means for promoting combustion.

4. Method according to claim 1, wherein the means for promoting combustion of the residual combustible gases in the exhaust gas flow are a catalyst.

5. Method according to claim 1, wherein the means for promoting combustion of the residual combustible gases in the exhaust gas flow are a thermal reactor.

6. Method according to claim 1, wherein the engine is operated at a different air/fuel ratio λ to the air/fuel ratio corresponding to the variation in slope of the temperature curve of the exhaust gases according to λ.

7. Method according to claim 1, wherein the variation in slope of the temperature curve of the exhaust gases according to λ occurs at the maximum temperature.

8. Method according to claim 2, wherein the engine is operated at a different air/fuel ratio λ to the air/fuel ratio corresponding to the variation in slope of the temperature curve of the exhaust gases according to λ.
